(19) United States
(12) Patent Application Publication
(10) Pub. No.: US 2004/0144865 A1
(43) Pub. Date: Jul. 29, 2004

(54) Pump accessory holster

(76) Inventor: Daniel R. Boas, Byron, NY (US)

Correspondence Address: Christopher E. Blank, Esq., JAECKLE FLEISCHMAN & MUGEL, LLP, Suite 200, 39 State Street, Rochester, NY, 14610-1310, US

(21) Appl. No.: 10/731,957

(22) Filed: Dec. 10, 2003

Related U.S. Application Data
(60) Provisional application No. 60/432,215, filed on Dec. 10, 2002.

(51) Int. Cl. B05B 9/04

(52) U.S. Cl. 239/373

(57) ABSTRACT

The present invention relates to a spray wand holster that is affixable to a sprayer. The holster comprises a main body with a means for affixing the body to a sprayer, a nozzle holder, and a means for clipping the wand a sprayer so that when a sprayer wand nozzle is inserted into the nozzle holder the wand of the sprayer can be clipped to the holster. The spray wand holster may also include a clipping means for holding the sprayer wand in a horizontal orientation, means for holding additional nozzles or other paraphernalia.

### CROSS-REFERENCE TO RELATED APPLICATIONS

This application claims the benefit of U.S. Provisional Patent Application Serial No. 60/432,215, filed Dec. 10, 2002 (Attorney Docket No. 12781.153302).

### BACKGROUND

The present invention comprises an apparatus that attaches to a pump spray container for holding an associated sprayer extension rod assembly as well as associated accessories.

When transporting or storing a pump sprayer, it is important to assure that the associated extension rod assembly is securely attached thereto. The extension rod assembly is generally attached to a flexible hose originating from the pump spray container. If the extension rod assembly can not be attached to the pump spray container, the operator is required to manually carry it, or allow it to drag behind, most likely resulting in damage to extension rod assembly and hose.

What is needed in the art is an apparatus that easily attaches to a pump spray container for holding the extension rod assembly. What is further needed in the art is an apparatus that attaches to a pump spray container that holds spare nozzles and other associated peripheral items.

### SUMMARY OF THE INVENTION

The present invention relates to a spray wand holster that is affixable to a sprayer. The holster comprises a main body with a means for affixing the body to a sprayer, a nozzle holder, and a means for clipping the wand a sprayer so that when a sprayer wand nozzle is inserted into the nozzle holder the wand of the sprayer can be clipped to the holster. The spray wand holster may also include a clipping means for holding the sprayer wand in a horizontal orientation, means for holding additional nozzles or other paraphernalia.

### BRIEF DESCRIPTION OF THE FIGURES

FIG. 1 shows a perspective view of one embodiment of the present invention.

FIG. 2 shows a perspective view of a second embodiment of the invention

FIG. 3 shows a view of the invention being used on a sprayer tank.

FIG. 4 shows a sprayer.

FIG. 5 shows a third embodiment of the invention.

### DETAILED DESCRIPTION

The apparatus of the present invention provides an sprayer accessory holster that easily attaches to a sprayer and securely holds the spray wand assembly and nozzle, as well as associated accessories.

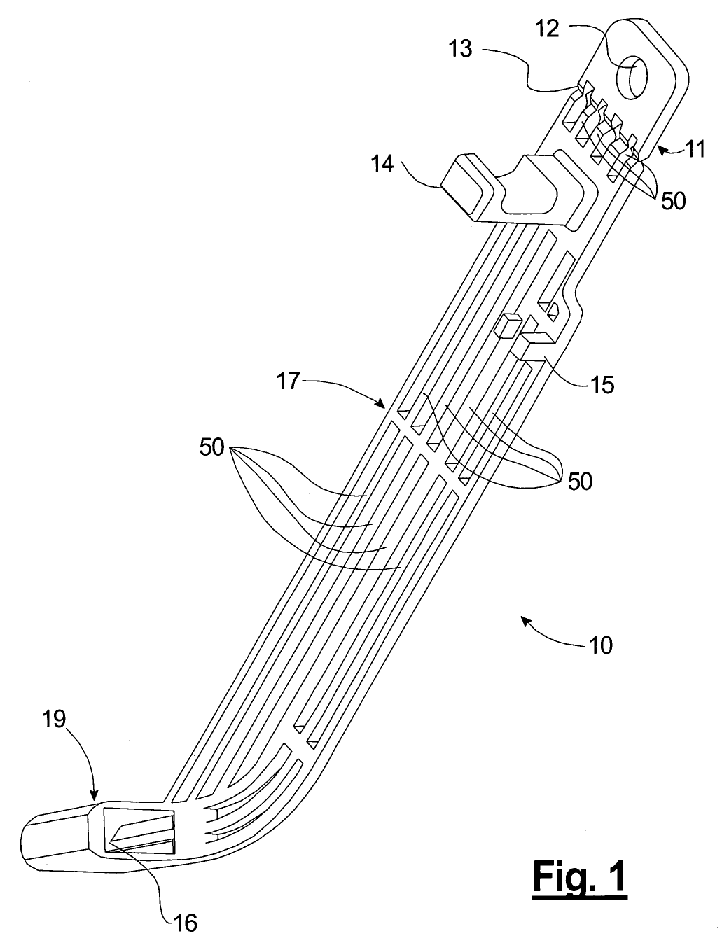

Referring to FIG. 1, the sprayer accessory holster 10 of the present invention comprises an upper end 11, having a attachment means 12, in this particular assembly a rotary bore. The upper end 11 is hingedly attached to the main body 17 at hinge section 13, thereby allowing upper section 12 to pivot at an angle relative to the body section 17. The body section 17 further comprises an upper clip 14 for attaching sprayer wand assembly to the holster 10 during filling. Additionally, the body section comprises a extension rod clip 15 for receiving and securely holding the extension rod and against the body section 17 of the holster 10. At the lower end 19 of the holster 10 is a nozzle holder 16 for receiving the nozzle end of the extension rod assembly.

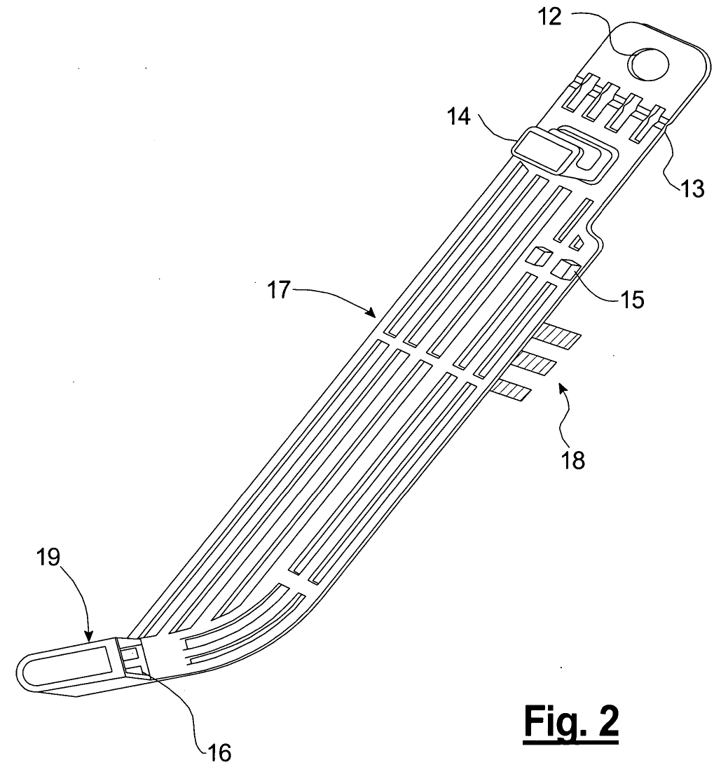

Referring now to FIG. 2, an additional embodiment of the present invention further comprises a series of prongs 18 extending outward from the body section 17. The prongs 18 are suitable for holding extra nozzles, or other peripheral items.

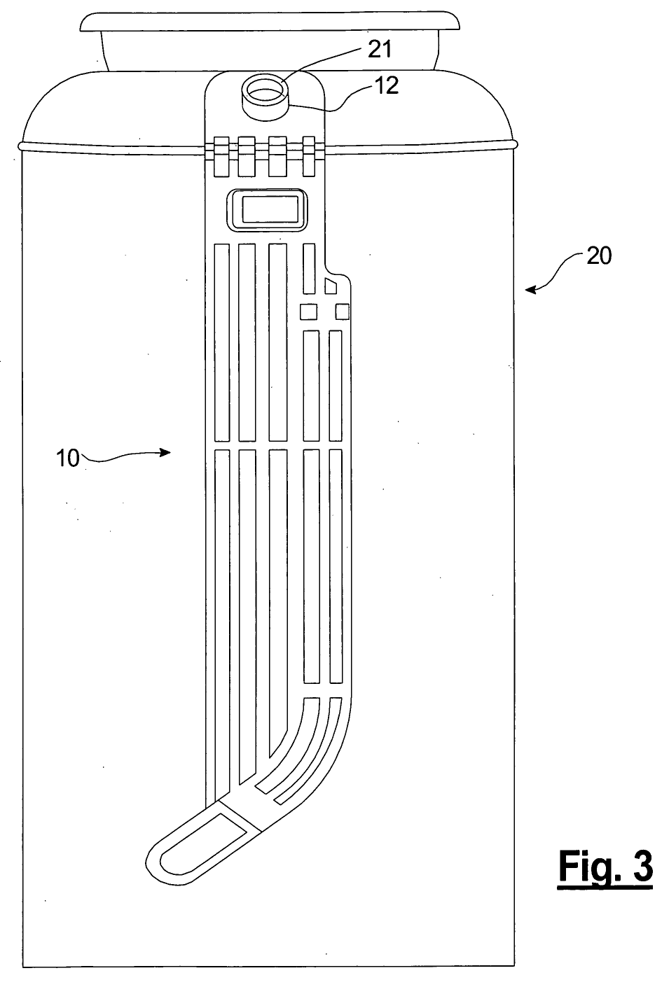

Referring now to FIG. 3, we see the apparatus of the present invention 10 attached to a sprayer 20. Generally, the sprayer accessory holster 10 is attached to the sprayer 20 by inserting hose nipple 21 through the annular bore 12. The holster 10 is held in place by reattaching the hose (not shown), and hose clamp (also not shown) over the nipple 21.

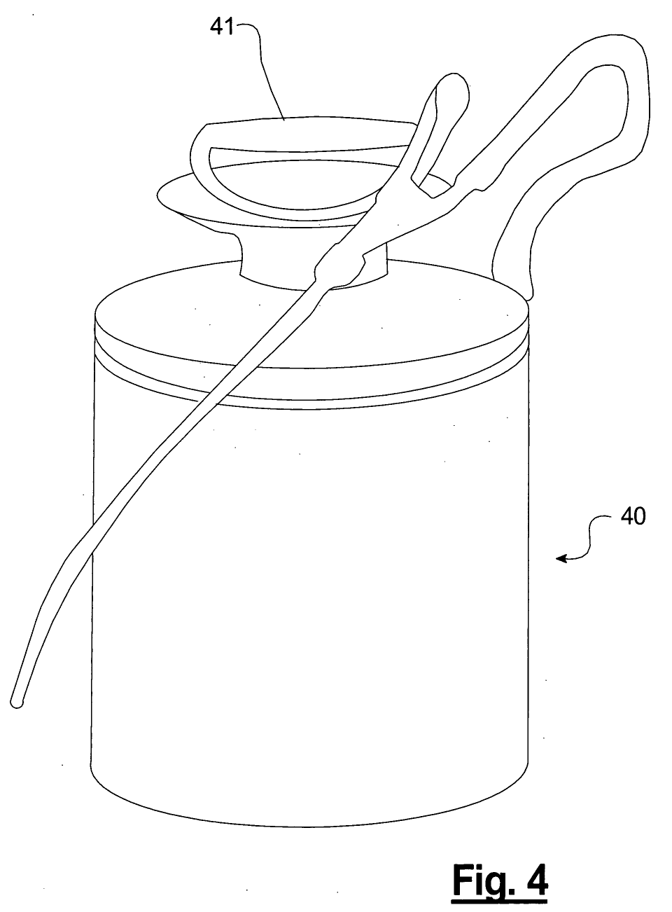

FIG. 4 shows a pump sprayer 40 where the pump sprayer further comprises a pump handle 41. During filling of the sprayer, the apparatus 10 can be attached to pump handle 41 at clip 14.

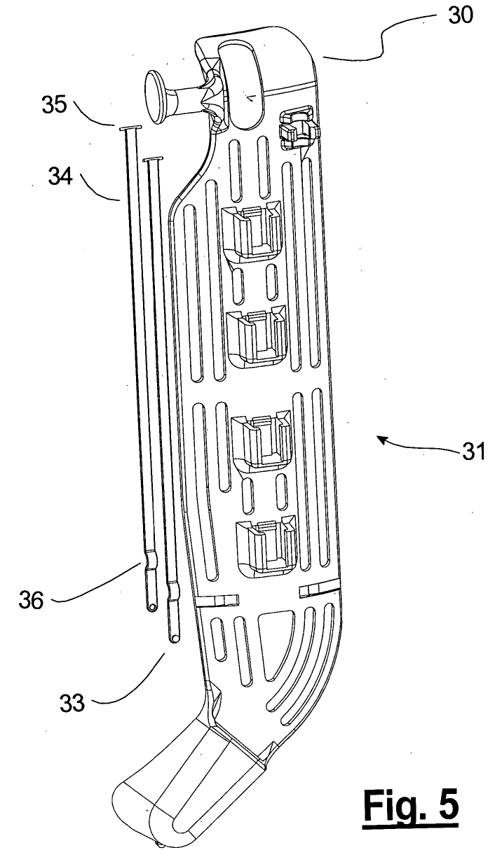

FIG. 5 shows a further embodiment of the present invention where the attaching means are a clip or curved surface (30) to conform to a specific sprayer. The body of this embodiment (31) conforms to the sprayer, as does the Nozzle holster (32) so that the assembly can be attached to the sprayer by use of a lashing belt (33,34) shown here as a two piece system. The belt would be configured to lash around a sprayer and connect to the holster with inserts (35) under tension provided by expansion loops (36).

Finally, FIG. 1 illustrates a holster 10 having a series of ribs 50. However, additional embodiments are contemplated of the holster without ribs, or with a holster whose body is solid. The holster may be made of durable plastic or metal and may also be made from the combination of several pieces. The body of the holster may be made of flexible material that under pressure would conform to the body of the sprayer tank. Alternately the body could be made of a rigid material that has been manufactured to conform to the intended sprayer tank body for which the holster has been designed.

While this invention has been described as having a specific embodiment, the present invention can be further modified within the spirit and scope of this disclosure. This application is therefore intended to cover any variations, uses, or adaptations of the present invention using the general principles disclosed herein.

What is claimed is:

1. A sprayer wand holster comprising:
a main body with an upper portion and a lower portion;
means for securing said body to a sprayer tank;
means for holding a nozzle of a spray wand disposed at the lower portion of said body; and
means for clipping said spray wand to the upper portion of said body.

2. The sprayer wand holster of claim 1 wherein said main body is shaped to conform to the body of said sprayer tank.

3. The sprayer wand holster of claim 1 wherein said main body is made of flexible plastic material so that under tension said body may conform to the body of said sprayer tank.

4. The sprayer wand holster of claim 1 wherein said holster further comprises a means for holding a sprayer wand horizontal.

5. A sprayer with a spray hose with a spray wand/nozzle and a spray tank and where the improvement comprises a holster comprising a main body; means for securing said main body to said spray tank; means for holding said nozzle and means for clipping the spray wand and securing said wand to said holster.

6. The sprayer of claim 5 wherein said main body is shaped to conform to the body of said sprayer tank.

7. The sprayer of claim 5 wherein said main body is made of flexible plastic material so that under tension said body may conform to the body of said sprayer tank.

8. The sprayer of claim 5 wherein said holster further comprises a means for holding a sprayer wand horizontal.
